(19) United States
(12) Patent Application Publication
(10) Pub. No.: US 2008/0010179 A1
(43) Pub. Date: Jan. 10, 2008

(54) CHARGING FOR OFFNET SESSIONS BETWEEN AN IMS NETWORK AND A LEGACY NETWORK

(76) Inventors: Yigang Cai, Naperville, IL (US); Shiyan Hua, Lisle, IL (US)

Correspondence Address: DUFT BORNSEN & FISHMAN, LLP, 1526 SPRUCE STREET, SUITE 302, BOULDER, CO, 80302, US

(21) Appl. No.: 11/456,323

(22) Filed: Jul. 10, 2006

(51) Int. Cl. G07F 19/00

(52) U.S. Cl. 705/34

(57) ABSTRACT

Communication networks and methods are disclosed for providing charging for offnet sessions between an IMS network and a legacy network. The IMS network generates a charging ID for the session and includes the charging ID in charging records that are generated for the session. The IMS network also transmits the charging ID to the legacy network in the signaling transmitted from the IMS network to the legacy network for the session. The legacy network receives the charging ID from the IMS network, and includes the charging ID in a charging record generated for the session. The billing system can then correlate charging records generated by the IMS network for the session with a charging record generated by the legacy network for the session based on the charging ID included in the charging records.

### BACKGROUND OF THE INVENTION

1. Field of the Invention

The invention is related to the field of communications, and in particular, to providing systems and methods for correlating charging records for offnet sessions between an IMS network and a legacy network.

2. Statement of the Problem

For calls in conventional telecommunication networks, such as a PSTN, a GSM/UMTS network, or a CDMA/ANSI-41 network, a switch monitors the duration of a call and generates a Call Detail Record (CDR) when the call is completed. A billing system pulls the CDR from the switch, and generates a billing invoice for the call based on the information provided in the CDR, such as call duration, calling party, called party, etc.

Some service providers are implementing IP Multimedia Subsystem (IMS) networks in additional to conventional telecommunication networks. In an IMS network, each of the network nodes serving a session, such as a Call Serving Control Function (CSCF), an Application Server (AS), etc, generate charging information for the session. The network nodes transmit charging messages to a Charging Collector Function (CCF) or Charging Data Function (CDF) through the Diameter Rf interface. The charging messages include an IMS Charging Identifier (ICID) and record type. The CCF (or CDF) generates a Charging Data Record (CDR) per network node that includes the ICID and record type for the session. The billing system then pulls the CDRs from the CCF, and correlates the CDRs for the session based on the ICID included in each CDR. The billing system may then generate a billing invoice based on the correlated CDRs.

When a session is established in the IMS network, the ICID is generated by the first network node that processes the session-initiating SIP signaling, such as a SIP Invite message. The value of the ICID is a mandatory part of the P-Charging-Vector for the SIP signaling used in the IMS network. The ICID value is globally unique across all IMS networks for a time period, such as at least one month. The ICID is used in subsequent SIP messages for the session (e.g., 200 OK message, (re)Invite message, BYE message, etc) until the session is terminated.

Some sessions (calls) may be between a conventional telecommunication network and an IMS network, which is referred to as an offnet session. One problem in present offnet sessions is that there is no efficient way to correlate charging records (e.g., CDRs) generated by the IMS network for a session with charging records generated by the conventional telecommunication network for the session. A billing system may attempt to correlate charging records using a calling number for the session and/or a called number for the session, but this may be difficult as the calling number and called number in the conventional telecommunication network may be in a different format than the IMS network. For instance, in a conventional telecommunication network, the called number is a ten digit number while the called number in an IMS network may be a SIP URI, a network address plus a number, or a TEL URL. The billing system cannot efficiently correlate the charging records using the calling number and/or the called number.

### SUMMARY OF THE SOLUTION

The invention solves the above and other related problems with an improved way of correlating charging records (e.g., CDRs) for offnet sessions between an IMS network and a legacy network using a charging identifier (ID). The charging ID is included in charging records generated in the IMS network to correlate multiple charging records generated for multiple network nodes that serve a session. According to features and aspects herein, the IMS network passes the charging ID to the legacy network so that the legacy network can include the charging ID in a charging record generated by the legacy network. A billing system can advantageously correlate the charging records for the session generated by the IMS network and the charging record for the session generated by the legacy network in an efficient manner using the charging ID.

In one embodiment, a communication network includes an IMS network, a legacy network, and a billing system. For an offnet session between the IMS network and the legacy network, the communication network operates as follows. The IMS network generates a charging ID for the session. At some point during or after the session, the IMS network generates a first charging record for the session that includes the charging ID, and transmits the first charging record for the session to the billing system. To initiate or maintain the session, session signaling is exchanged between the IMS network and the legacy network. To exchange the session signaling, the IMS network generates legacy network signaling for the session. The legacy network signaling is the signaling used in the legacy network for the session, such as ISUP. The IMS network includes the charging ID in the legacy network signaling, and transmits the legacy network signaling to the legacy network. The legacy network receives the legacy network signaling for the session from the IMS network. The legacy network signaling includes the charging ID. At some point during or after the session, the legacy network generates a second charging record for the session that includes the charging ID, and transmits the second charging record for the session to the billing system.

The billing system receives the first charging record (and possibly multiple other charging records) from the IMS network, and receives the second charging record from the legacy network. The billing system correlates the first charging record and the second charging record based on the charging ID included in the first charging record and the second charging record. The billing system generates a billing invoice for the session based on the first charging record and the second charging record (and possibly other charging records).

The invention may include other exemplary embodiments described below.

### DESCRIPTION OF THE DRAWINGS

The same reference number represents the same element or same type of element on all drawings.

FIG. 1 illustrates a communication network in an exemplary embodiment of the invention.

FIG. 2 is a flow chart illustrating a method of operating an IMS network in an exemplary embodiment of the invention.

FIG. 3 is a flow chart illustrating a method of operating a legacy network in an exemplary embodiment of the invention.

FIG. 4 is a flow chart illustrating a method of operating a billing system in an exemplary embodiment of the invention.

FIG. 5 illustrates another communication network in an exemplary embodiment of the invention.

FIGS. 6-7 illustrate interworking in an MGCF for signaling from a PSTN to an IMS network in an exemplary embodiment of the invention.

FIGS. 8-9 illustrate interworking in a MGCF for signaling from an IMS network to a PSTN in an exemplary embodiment of the invention.

FIG. 10 is a message diagram illustrating a session flow for a session initiated in a PSTN in an exemplary embodiment of the invention.

FIG. 11 is a message diagram illustrating a session flow for a session initiated in an IMS network in an exemplary embodiment of the invention.

### DETAILED DESCRIPTION OF THE INVENTION

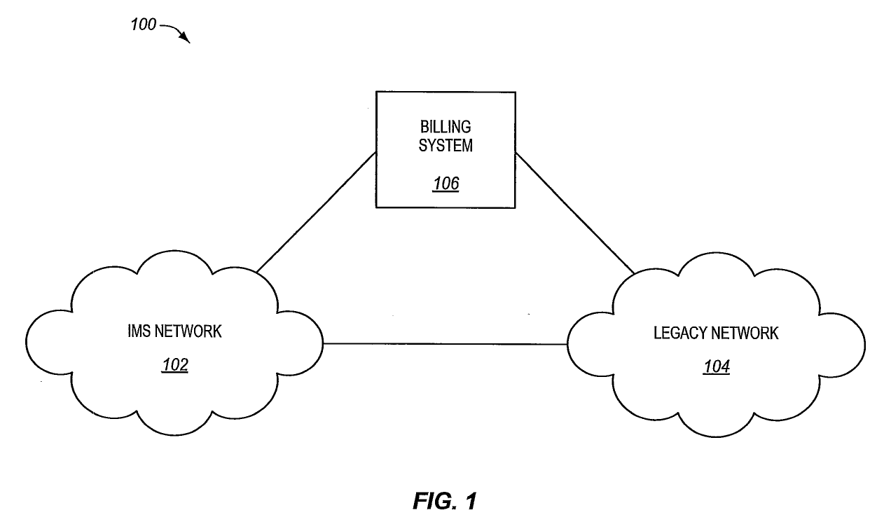

FIGS. 1-11 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates a communication network 100 in an exemplary embodiment of the invention. Communication network 100 includes an IMS network 102, a legacy network 104, and a billing system 106. Communication network 100 is adapted to support offnet sessions between IMS network 102 and legacy network 104. An offnet session comprises a call or session between a subscriber (not shown) of IMS network 102 and a subscriber (not shown) of legacy network 104. The session may be initiated by the subscriber of IMS network 102 or the subscriber of legacy network 104. IMS network 102 comprises a network that implements the IP Multimedia Subsystem (IMS), such as suggested by the 3GPP. Legacy network 104 comprises any network other than an IMS network, such as a PSTN, a GSM/UMTS network, or a CDMA/ANSI-41 network. Legacy network 104 may represent an existing type of network or a newly-developed type of network. Billing system 106 comprises any system that generates bills or billing invoices for sessions. Billing system 106 may be associated with IMS network 102 and/or legacy network 104, or may be an independent system.

Assume for this embodiment that a session is established or is initiated between a subscriber (not shown) of IMS network 102 and a subscriber (not shown) of legacy network 104. According to features and aspects herein, communication network 100 is adapted to provide improved methods of correlating charging records generated by IMS network 102 with charging records generated by legacy network 104.

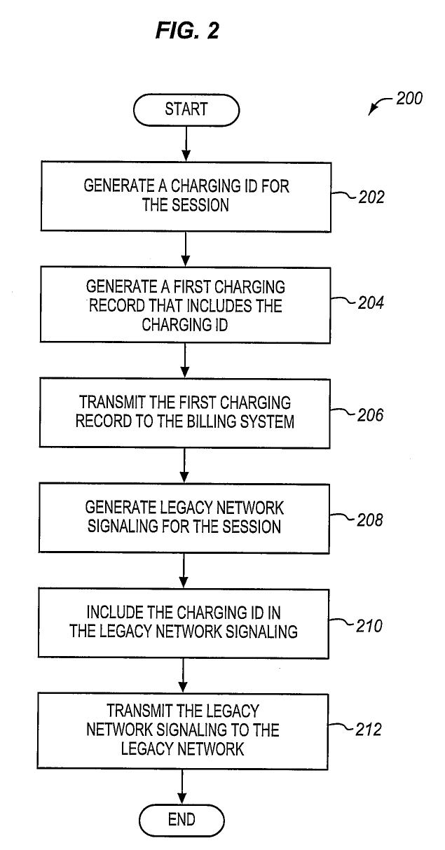

FIG. 2 is a flow chart illustrating a method 200 of operating IMS network 102 in an exemplary embodiment of the invention. The steps of method 200 will be described with a general reference to IMS network 102 in FIG. 1. IMS network 102 includes one or more network nodes (not shown) that execute the steps of method 200 that are not shown in FIG. 1 for the sake of brevity. The steps of the flow chart in FIG. 2 are not all inclusive and may include other steps not shown.

In step 202, IMS network 102 generates a charging identifier (ID) for the session. A charging ID may comprise an IMS Charging Identifier (ICID) as described by the 3GPP. In step 204 at some point during or after the session, IMS network 102 generates a first charging record for the session that includes the charging ID. The first charging record may comprise a Charging Data Record (CDR) as described by the 3GPP. IMS network 102 may generate multiple charging records for the session, with each charging record including the charging ID. The charging ID is subsequently used by billing system 106 to correlate the multiple charging records for the session. In step 206, IMS network 102 transmits the first charging record for the session to billing system 106.

In step 208, IMS network 102 generates legacy network signaling for the session. To initiate or maintain the session, IMS network 102 exchanges session signaling with legacy network 104. The session signaling used in IMS network 102, such as Session Initiation Protocol (SIP) signaling, is referred to herein as IMS network signaling. The session signaling used in legacy network 104, such as ISUP signaling, is referred to herein as legacy network signaling. In generating the legacy network signaling, IMS network 102 may translate IMS network signaling to legacy network signaling.

In step 210, IMS network 102 includes the charging ID in the legacy network signaling. IMS network 102 may identify a particular parameter in the legacy network signaling, and then populate this parameter with the charging ID. For instance, if the legacy network signaling comprises ISUP signaling, then IMS network 102 may populate a correlationID parameter in the ISUP signaling with the charging ID. In step 212, IMS network 102 transmits the legacy network signaling to the legacy network 104.

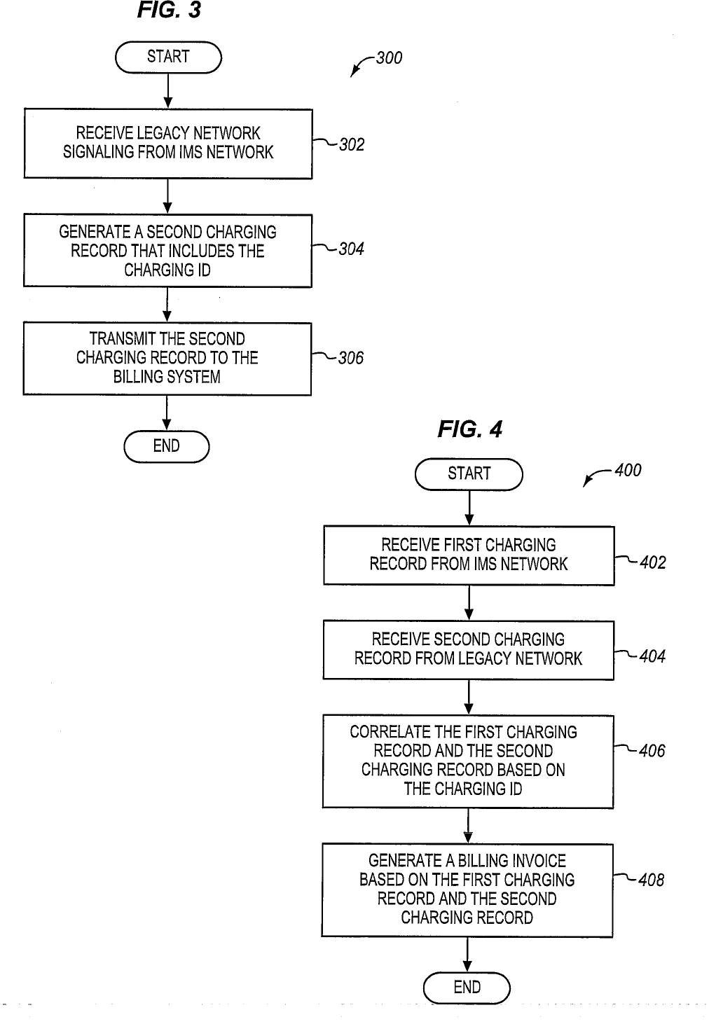

FIG. 3 is a flow chart illustrating a method 300 of operating legacy network 104 in an exemplary embodiment of the invention. The steps of method 300 will be described with a general reference to legacy network 104 in FIG. 1. Legacy network 104 includes one or more network nodes (not shown) that execute the steps of method 300 that are not shown in FIG. 1 for the sake of brevity. The steps of the flow chart in FIG. 3 are not all inclusive and may include other steps not shown.

In step 302, legacy network 104 receives the legacy network signaling from IMS network 102. The legacy network signaling includes the charging ID generated by IMS network 102. In step 304, at some point during or after the session, legacy network 104 generates a second charging record for the session that includes the charging ID. The second charging record may comprise a Call Detail Record (CDR). Legacy network 104 may generate multiple charging records for the session, with each charging record including the charging ID. In step 306, legacy network 104 transmits the second charging record for the session to billing system 106.

FIG. 4 is a flow chart illustrating a method 400 of operating billing system 106 in an exemplary embodiment of the invention. The steps of method 400 will be described with a general reference to billing system 106 in FIG. 1. The steps of the flow chart in FIG. 4 are not all inclusive and may include other steps not shown.

In step 402, billing system 106 receives the first charging record from IMS network 102. Billing system 106 may receive multiple charging records from IMS network 102, but one charging record is described merely for illustration. In step 404, billing system 106 receives the second charging record from legacy network 104. Billing system 106 may receive multiple charging records from legacy network 104, but one charging record is described merely for illustration. In step 406, billing system 106 correlates the first charging record and the second charging record based on the charging ID included in the first charging record and the second charging record. In step 408, billing system 106 generates a billing invoice for the session based on the first charging record and the second charging record (and possibly other charging records).

Communication network 100 as described in the above methods 200, 300, and 400 provides an improved way of correlating charging records for offnet sessions using the charging ID from IMS network 102. IMS network 102 includes the charging ID in the charging records it generates for the session so that billing system 106 can subsequently correlate the charging records for the session. IMS network 102 also passes the charging ID to legacy network 104 through the legacy network signaling so that legacy network 104 can similarly include the charging ID in the charging record it generates for the session. Billing system 106 can thus efficiently correlate the charging record(s) generated by legacy network 104 with the charging record(s) generated by IMS network 102 in order to generate a billing invoice for the session.

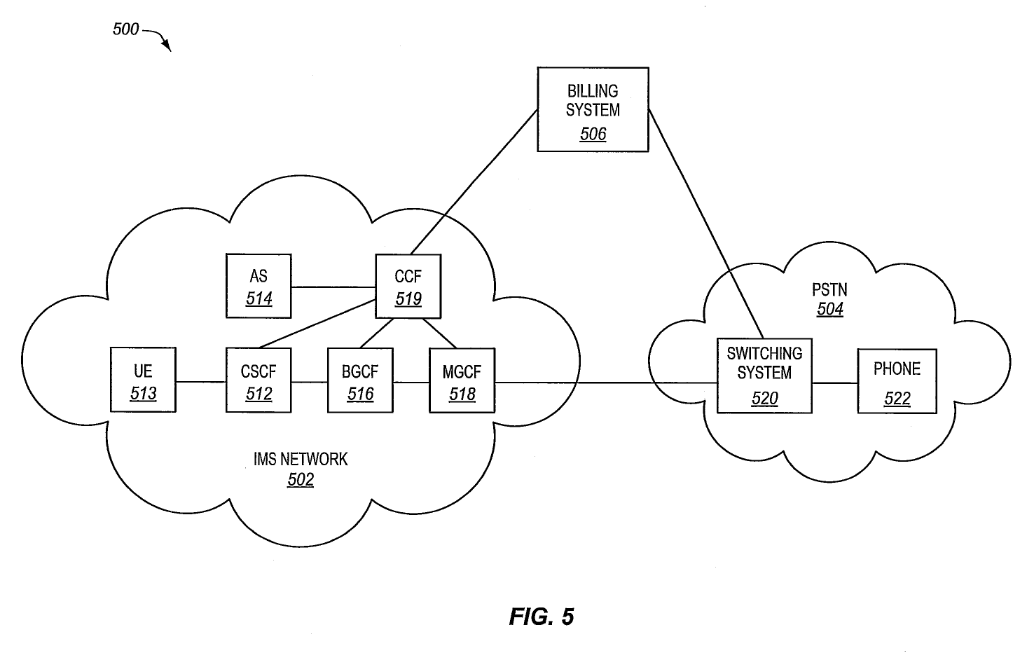

FIG. 5 illustrates another communication network 500 in an exemplary embodiment of the invention. Communication network 500 includes an IMS network 502, a PSTN 504, and a billing system 506. Although PSTN 504 is illustrated in FIG. 5, PSTN 504 may be replaced with any legacy network. IMS network 502 includes a Call Session Control Function (CSCF) 512 adapted to serve user equipment (UE) 513 for a session (call), one or more Application Servers (AS) 514, a Breakout Gateway Control Function (BGCF) 516, a Media Gateway Control Function (MGCF) 518, and a Charging Collector Function (CCF) 519. IMS network 502 may include other systems or servers not shown in FIG. 5. PSTN 504 includes a switching system 520 adapted to serve a phone 522 for a session. PSTN 504 may include other systems or servers not shown in FIG. 5. Communication network 500 is adapted to support offnet sessions between IMS network 502 and PSTN 504.

MGCF 518 is located at the edge of IMS network 502 and is adapted to interwork signaling between IMS network 502 and PSTN 504 for the session. IMS network 502 uses SIP signaling, and PSTN 504 uses ISUP signaling, so MGCF 518 is adapted to interwork between SIP and ISUP in this embodiment. MGCF 518 may be referred to generally as a gateway system in other embodiments.

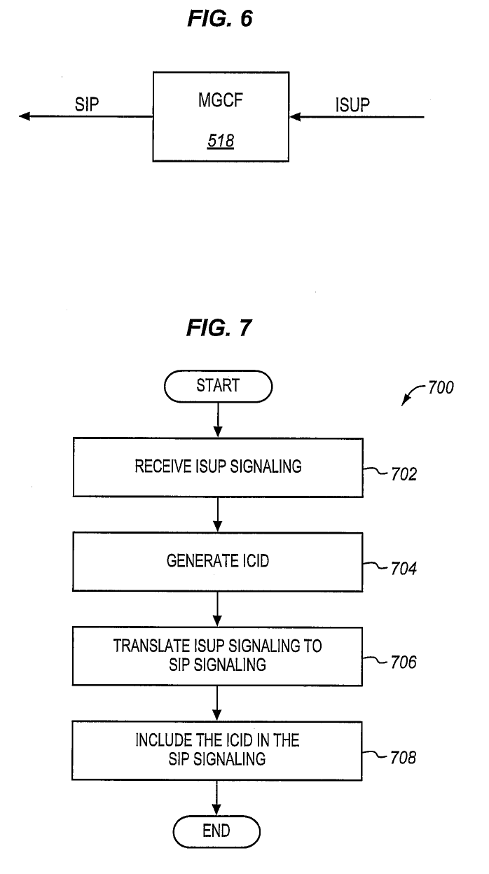

FIGS. 6-7 illustrate interworking in MGCF 518 for signaling from PSTN 504 to IMS network 502 in an exemplary embodiment of the invention. Although ISUP signaling and SIP signaling are discussed in FIGS. 6-7, the functionality of MGCF 518 applies equally to other types of IMS network signaling and legacy network signaling. In step 702 in FIG. 7, MGCF 518 receives ISUP signaling (e.g., an IAM) from PSTN 504, such as from switching system 520. Responsive to receiving the ISUP signaling, MGCF 518 generates an ICID for the session in step 704. The assumption at this point is that MGCF 518 is the first network node in IMS network 502 to receive signaling for the session. If an ICID has already been generated in IMS network 502 for the session, then step 704 is skipped. MGCF 518 then translates the ISUP signaling to SIP signaling in step 706. For instance, MGCF 518 may convert an ISUP IAM to a SIP Invite. MGCF 518 then includes the ICID in a P-Charging-Vector parameter of the SIP signaling in step 708. MGCF 518 may then transmit the SIP signaling to the appropriate network node in IMS network 502, such as CSCF 512.

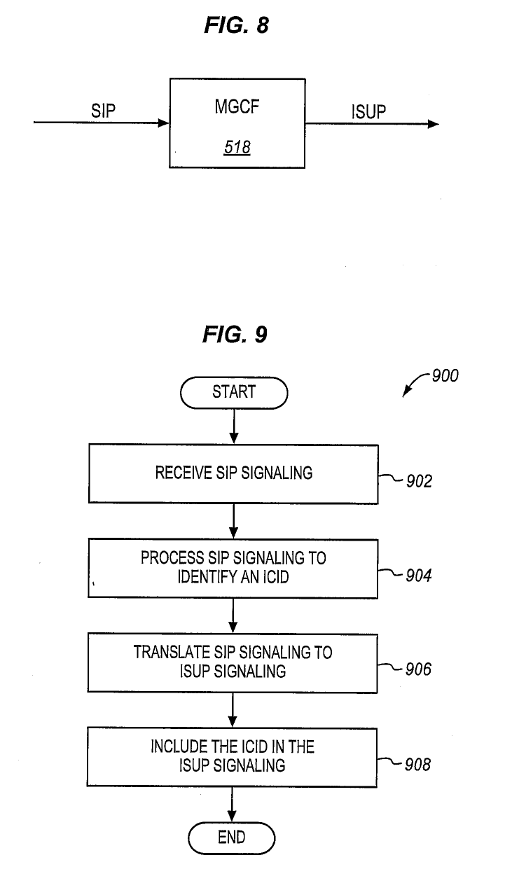

FIGS. 8-9 illustrate interworking in MGCF 518 for signaling from IMS network 502 to PSTN 504 in an exemplary embodiment of the invention. Although ISUP signaling and SIP signaling are discussed in FIGS. 8-9, the functionality of MGCF 518 applies equally to other types of IMS network signaling and legacy network signaling. In step 902 in FIG. 9, MGCF 518 receives SIP signaling (e.g., a SIP Invite) from IMS network 502, such as from CSCF 512. Responsive to receiving the SIP signaling, MGCF 518 processes the P-Charging-Vector parameter in the SIP signaling to identify an ICID for the session (if one exists) in step 904. MGCF 518 translates the SIP signaling to ISUP signaling in step 906. If the P-Charging-Vector parameter in the SIP signaling includes an ICID, then MGCF 518 includes the ICID in a correlationID parameter of the ISUP signaling in step 908. MGCF 518 then transmits the ISUP signaling to the appropriate network node in PSTN 504, such as switching system 520.

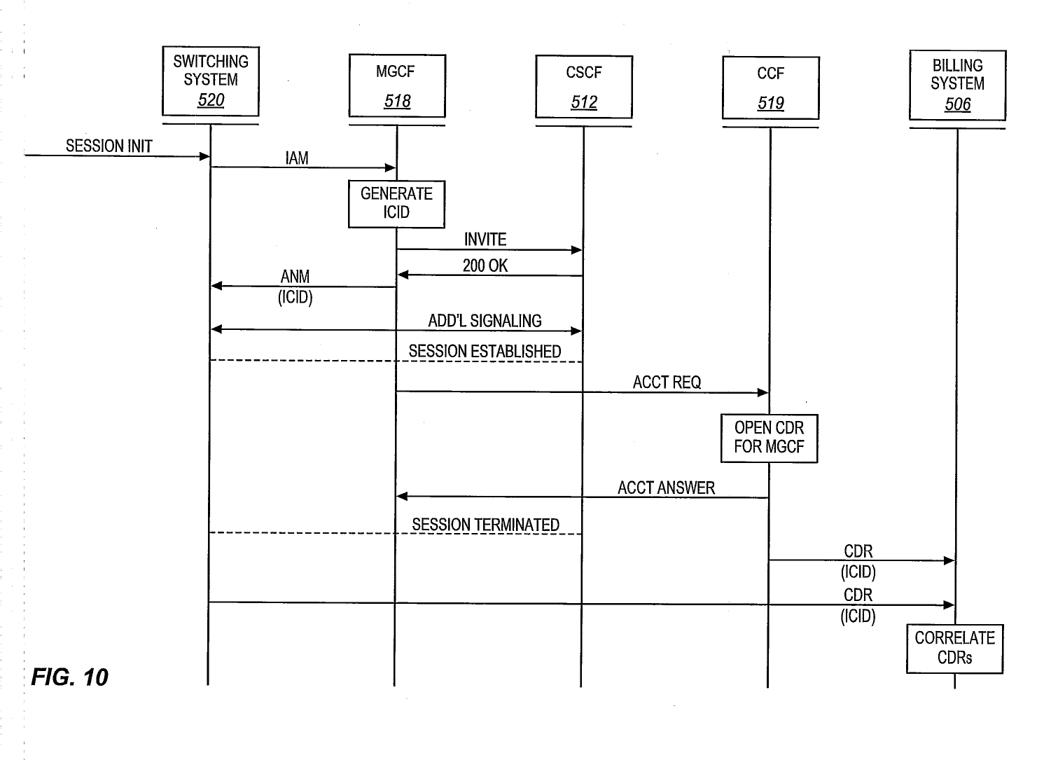

FIG. 10 is a message diagram illustrating a session flow for a session initiated in PSTN 504 in an exemplary embodiment of the invention. In FIG. 5, phone 522 initiates a session with UE 513 such as by dialing the number for UE 513. Responsive to session initiation, switching system 520 generates an IAM message, and transmits the IAM to MGCF 518 (see FIG. 10). Responsive to receiving the IAM, MGCF 518 generates an ICID for the session. MGCF 518 also translates the IAM to a SIP Invite message, and transmits the Invite message to CSCF 512 through BGCF 516 (see FIG. 5). The Invite message includes the ICID as well as all other SIP messages. CSCF 512 forwards the Invite message to UE 513. If UE 513 accepts the session initiation, then UE 513 transmits a SIP 200 OK message to CSCF 512. CSCF 512 forwards the 200 OK message to MGCF 518 through BGCF 516 (see FIG. 5). MGCF 518 translates the 200 OK message to an ISUP Answer message (ANM), and populates a correlationID parameter in the ANM with the ICID. MGCF 518 then transmits the ANM to switching system 520. MGCF 518 continues to interwork signaling between PSTN 504 and IMS network 502 to establish and maintain the session. In interworking SIP to ISUP, MGCF 518 includes the ICID in the ISUP signaling.

MGCF 518 also transmits an Accounting Request message that includes the ICID to CCF 519. The Accounting Request message includes an Account-Record-Type parameter indicating START_RECORD to record the start of a session and the start of a media component. CCF 519 acknowledges the reception of the Accounting Request message with an Accounting Answer message, and opens a CDR for MGCF 518 that includes the ICID. Other network nodes in IMS network 502 may transmit also Accounting Request messages to CCF 519, such as AS 514.

When the session terminates, CCF 519 transmits the CDRs for the session to billing system 506. Similarly, switching system 520 transmits a CDR for the session to billing system 506. The CDRs from CCF 519 and the CDR from switching system 520 each include the ICID for the session. Billing system 506 may then correlate the CDRs based on the ICID to generate a billing invoice for the session.

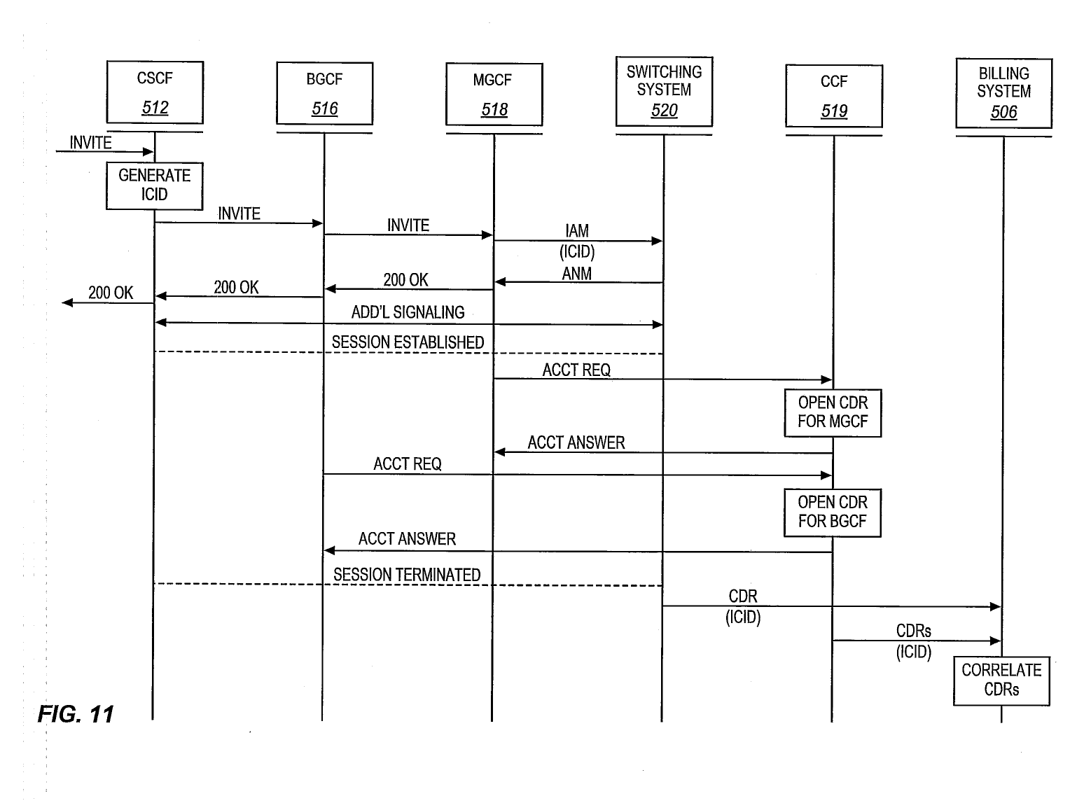

FIG. 11 is a message diagram illustrating a session flow for a session initiated in IMS network 502 in an exemplary embodiment of the invention. UE 513 initiates a session with phone 522 by transmitting a SIP Invite message to CSCF 512. CSCF 512 receives the Invite message, and generates an ICID for the session. CSCF 512 forwards the Invite message to BGCF 516, where the P-Charging-Vector parameter in the Invite message includes the ICID. BGCF 516 forwards the Invite message to MGCF 518. MGCF 518 translates the Invite message to an ISUP IAM. MGCF 518 identifies the ICID in the P-Charging-Vector parameter in the Invite message (if one exists). MGCF 518 then populates a correlationID parameter in the IAM with the ICID identified from the P-Charging-Vector parameter. MGCF 518 transmits the IAM to switching system 520. Switching system 520 attempts to connect the session to phone 522 responsive to the IAM. If switching system 520 is successful, then switching system 520 transmits an ANM to MGCF 518. MGCF 518 translates the ANM to a SIP 200 OK message. MGCF 518 then transmits the 200 OK message to CSCF 512. MGCF 518 transmits the 200 OK message to UE 513 to setup the session. MGCF 518 continues to interwork signaling between PSTN 504 and IMS network 502 to establish and maintain the session. In interworking SIP to ISUP, MGCF 518 includes the ICID in the ISUP signaling.

MGCF 518 also transmits an Accounting Request message that includes the ICID to CCF 519. The Accounting Request message includes an Account-Record-Type parameter indicating START_RECORD to record the start of a session and the start of a media component. CCF 519 acknowledges the reception of the Accounting Request message with an Accounting Answer message, and opens a CDR for MGCF 518 that includes the ICID. Similarly, BGCF 516 transmits an Accounting Request message that includes the ICID to CCF 519. The Accounting Request message includes an Account-Record-Type parameter indicating START_RECORD to record the start of a session and the start of a media component. CCF 519 acknowledges the reception of the Accounting Request message with an Accounting Answer message, and opens a CDR for BGCF 516 that includes the ICID. Other network nodes in IMS network 502 may transmit also Accounting Request messages to CCF 519, such as AS 514.

When the session terminates, CCF 519 transmits the CDRs for the session to billing system 506. Similarly, switching system 520 transmits a CDR for the session to billing system 506. The CDRs from CCF 519 and the CDR from switching system 520 each include the ICID for the session. Billing system 506 may then correlate the CDRs based on the ICID to generate a billing invoice for the session.

Communication network 500 provides an improved way of correlating CDRs for offnet sessions using the ICID from IMS network 502. By passing the ICID to PSTN 504 through ISUP signaling, PSTN 504 can include the ICID in CDRs much like IMS network 502 includes the ICID in CDRs. Billing system 506 can then more easily correlate CDRs from IMS network 502 and CDRs from PSTN 504 to generate a billing invoice for the session.

Although specific embodiments were described herein, the scope of the invention is not limited to those specific embodiments. The scope of the invention is defined by the following claims and any equivalents thereof.

We claim:

1. A method of providing charging for an offnet session between an IMS network and a legacy network, the method comprising:
generating a charging identifier (ID) in the IMS network for the session;
generating a first charging record for the session that includes the charging ID in the IMS network;
transmitting the first charging record for the session from the IMS network to a billing system;
generating legacy network signaling for the session in the IMS network;
including the charging ID in the legacy network signaling; and
transmitting the legacy network signaling from the IMS network to the legacy network.

2. The method of claim 1 further comprising:
receiving the legacy network signaling in the legacy network, wherein the legacy network signaling includes the charging ID;
generating a second charging record for the session that includes the charging ID; and
transmitting the second charging record for the session from the legacy network to the billing system.

3. The method of claim 2 further comprising:
receiving the first charging record from the IMS network and receiving the second charging record from the legacy network in the billing system;
correlating the first charging record and the second charging record based on the charging ID included in the first charging record and the second charging record; and
generating a billing invoice for the session based on the first charging record and the second charging record.

4. The method of claim 1 wherein the charging ID comprises an IMS Charging Identifier (ICID).

5. The method of claim 1 wherein:
the legacy network signaling comprises ISUP signaling; and
the step of including the charging ID in the legacy network signaling comprises including the charging ID in a correlationID parameter of the ISUP signaling.

6. The method of claim 1 wherein the legacy network comprises a PSTN, a GSM/UMTS network, or a CDMA/ANSI-41 network.

7. A communication network adapted to provide charging for offnet sessions, the communication network comprising:
a legacy network; and
an IMS network that communicates with the legacy network for an offnet session between the IMS network and the legacy network;
the IMS network is adapted to generate a charging identifier (ID) for the session, to generate a first charging record for the session that includes the charging ID, and to transmit the first charging record for the session to a billing system;
the IMS network is further adapted to generate legacy network signaling for the session, to include the charging ID in the legacy network signaling, and to transmit the legacy network signaling to the legacy network.

8. The communication network of claim 7 wherein the legacy network is adapted to:
receive the legacy network signaling from the IMS network wherein the legacy network signaling includes the charging ID;
generate a second charging record for the session that includes the charging ID; and
transmit the second charging record for the session to the billing system.

9. The communication network of claim 8 further comprising the billing system, wherein the billing system is adapted to:
receive the first charging record from the IMS network and receive the second charging record from the legacy network;
correlate the first charging record and the second charging record based on the charging ID included in the first charging record and the second charging record; and
generate a billing invoice for the session based on the first charging record and the second charging record.

10. The communication network of claim 7 wherein the charging ID comprises an IMS Charging Identifier (ICID).

11. The communication network of claim 7 wherein:
the legacy network signaling comprises ISUP signaling; and
the IMS network is further adapted to include the charging ID in a correlationID parameter of the ISUP signaling.

12. The communication network of claim 7 wherein the legacy network comprises a PSTN, a GSM/UMTS network, or a CDMA/ANSI-41 network.

13. The communication network of claim 7 wherein the IMS network includes a gateway system adapted to interwork session signaling between the IMS network and the legacy network, the gateway system is adapted to:
receive legacy network signaling from the legacy network;
generate the charging ID responsive to receiving the legacy network signaling;
translate the legacy network signaling to IMS network signaling; and
include the charging ID in the IMS network signaling.

14. The communication network of claim 13 wherein:
the IMS network signaling comprises SIP signaling; and
the gateway system is further adapted to include the charging ID in a P-Charging-Vector parameter of the SIP signaling.

15. The communication network of claim 13 wherein the gateway system is further adapted to:
receive IMS network signaling from the IMS network;
process the IMS network signaling to identify the charging ID in the IMS network signaling;
translate the IMS network signaling to legacy network signaling; and
include the charging ID in the legacy network signaling.

16. The communication network of claim 15 wherein:
the IMS network signaling comprises SIP signaling and the legacy network signaling comprises ISUP signaling; and
the gateway system is further adapted to identify the charging ID in a P-Charging-Vector parameter of the SIP signaling, and to include the charging ID from the P-Charging-Vector parameter in a correlationID parameter of the ISUP signaling.

17. A method of operating a gateway system to interwork session signaling between an IMS network and a legacy network for an offnet session, the method comprising:
receiving legacy network signaling from the legacy network;
generating a charging identifier (ID) responsive to receiving the legacy network signaling;
translating the legacy network signaling to IMS network signaling;
including the charging ID in the IMS network signaling; and
transmitting the IMS network signaling to the IMS network.

18. The method of claim 17 wherein:
the IMS network signaling comprises SIP signaling; and
the step of including the charging ID in the IMS network signaling comprises including the charging ID in a P-Charging-Vector parameter of the SIP signaling.

19. The method of claim 17 further comprising:
receiving IMS network signaling from the IMS network;
processing the IMS network signaling to identify the charging ID in the IMS network signaling;
translating the IMS network signaling to legacy network signaling;
including the charging ID in the legacy network signaling; and
transmitting the legacy network signaling to the legacy network.

20. The method of claim 19 wherein:
the IMS network signaling comprises SIP signaling and the legacy network signaling comprises ISUP signaling;
the step of processing the IMS network signaling to identify the charging ID in the IMS network signaling comprises processing the SIP signaling to identify the charging ID in a P-Charging-Vector parameter of the SIP signaling; and
the step of including the charging ID in the legacy network signaling comprises including the charging ID from the P-Charging-Vector parameter in a correlationID parameter of the ISUP signaling.
